(19) United States
(12) Patent Application Publication
(10) Pub. No.: US 2005/0238799 A1
(43) Pub. Date: Oct. 27, 2005

(54) Organic EL element and method of manufacturing the same

(75) Inventors: Shunichi Seki, Suwa-shi (JP); Hideyuki Kimura, Suwa-shi (JP); Masayuki Mitsuya, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/075,677

(22) Filed: Mar. 10, 2005

(30) Foreign Application Priority Data
Apr. 26, 2004 (JP) 2004-129652

(51) Int. Cl. B05D 5/12

(52) U.S. Cl. 427/66

(57) ABSTRACT

To provide an organic EL element in which adhesiveness of layers constituting the organic EL element, such as a functional layer, is enhanced, whereby high reliability due to extension of lifetime or enhancement of quality due to high brightness can be accomplished, and a method of manufacturing the organic EL element. There is provided an organic EL element having a functional layer including at least a light emitting layer between a pair of electrodes. The surface of at least one layer among the functional layer is rough.

### BACKGROUND

The present invention relates to an organic EL element having a functional layer with improved adhesiveness and characteristics and a method of manufacturing the organic EL element.

As flat-type display devices (flat panel displays), there have been known organic electroluminescence (EL) elements in which a light emitting layer made of an organic light emitting material is provided between a positive electrode and a cathode. In recent years, development of such organic EL elements has been intensive, and some organic EL devices as color display devices having a plurality of organic EL elements have been provided. Such organic EL devices are expected to be used as various display bodies or lighting devices, as well as the flat-type display devices.

In such organic EL devices (organic EL elements), decrease in cost or increase in reliability is a technical challenge for commercial application. Taking such a situation into consideration, there has been conventionally suggested a method of forming a functional layer such as a light emitting layer using an inkjet method (for example, see Patent Document 1) in order to manufacture an organic EL device. The method employing the inkjet method has brought about such advantages as decrease in cost, increase in area, and easy color coding of a light emitting layer for colorization.

When such an inkjet method is used, there has been suggested a method for suppressing leakage, etc., by controlling surface roughness of a positive electrode (transparent electrode), for example, within a range of 0.5 to 50 nm (for example, see Patent Document 2).

In order to enhance the adhesiveness between a substrate at the side of a pixel electrode (positive electrode) and an organic layer, there has been suggested a technique of providing a hydrophilic graft layer between the pixel electrodes and the organic layer (for example, see Patent Document 3 and Patent Document 4).
[Patent Document 1] Japanese Unexamined Patent Application Publication No. 10-12377
[Patent Document 2] Japanese Unexamined Patent Application Publication No. 2003-282272
[Patent Document 3] Japanese Unexamined Patent Application Publication No. 2003-249368
[Patent Document 4] Japanese Unexamined Patent Application Publication No. 2003-323983

### SUMMARY

However, in the technique of controlling the surface roughness of the positive electrode (transparent electrode) side, the leakage, etc. can be suppressed but the suppression of the leakage is not sufficient for obtaining high reliability such as extension of lifetime.

In the technique of providing the graft layer, since the base material for the organic layer provided on the graft layer is limited to a hydrophilic material, a light emitting material such as poly fluorene having an excellent light emitting characteristic cannot be used which is dissolved only in a nonpolar solvent. Even if the adhesiveness between the substrate and the organic layer is enhanced by providing the graft layer, existence of the graft layer prevents or may prevent, for example, injection of holes as carriers. For example, when a stacked structure is employed in which a hole injecting/transporting layer is formed on an electrode (substrate) and a light emitting layer is formed thereon, two-times patterning processes are twice required. Therefore, it is a question that lyophobic properties for going through the patterning processes may be maintained.

The present invention is contrived to solve the above-mentioned problems and it is an object of the present invention to provide an organic EL element in which adhesiveness of layers constituting the organic EL element, such as a functional layer, is enhanced, whereby high reliability due to extension of a lifetime or enhancement of quality due to high brightness can be accomplished, and a method of manufacturing the organic EL element.

In order to achieve the aforementioned object, an organic EL device according to the present invention has a functional layer including at least a light emitting layer between a pair of electrodes, wherein the surface of at least one layer among the functional layer is rough.

According to the organic EL device, in an interface between the functional layer and a layer stacked thereon, the contact area between both layers is increased due to the roughness of the surface of the functional layer. As a result, the adhesiveness between both layers can be enhanced, thereby accomplishing enhancement of reliability due to extension of lifetime, enhancement of heat resistance, etc. In addition, carrier injection efficiency between both layers can be enhanced, thereby accomplishing improvement of brightness and light emission efficiency.

In the organic EL device, it is preferable that the surface of the light emitting layer is rough.

Accordingly, since the contact area between the light emitting layer and a layer stacked thereon is increased, it is possible to accomplish enhancement of reliability, brightness, and light emission efficiency as described above.

In the organic EL device, it is preferable that the functional layer includes a hole injecting/transporting layer and the surface of the hole injecting/transporting layer is rough.

As a result, since the contact area between the hole injecting/transporting layer and a layer stacked thereon is increased, it is possible to accomplish enhancement of reliability, brightness, and light emission efficiency as described above.

According to the present invention, there is provided a method of manufacturing an organic EL device having a functional layer including at least a light emitting layer between a pair of electrodes, wherein at least one layer of the functional layers is formed by performing a coating step of applying a base material for the functional layer using a liquid droplet ejecting method and a drying step of drying the base material applied in the coating step using a vacuum dry method.

According to the method of manufacturing an organic EL device, since at least one layer becomes a layer of which the surface is rough by applying the base material for the functional layer using a liquid droplet ejecting method and then drying the base material using a vacuum dry method, a contact area between the functional layer and a layer stacked thereon in an interface between the layers can be increased as described above. Therefore, in the obtained organic EL element, the adhesiveness between the layers can be enhanced, thereby accomplishing enhancement of reliability such as extension of lifetime, improvement of a heat resistance, etc. In addition, carrier injection efficiency between the layers can be improved, thereby accomplishing enhancement of brightness and light emission efficiency.

In the method of manufacturing an organic EL device, it is preferable that the light emitting layer is formed by performing the coating step and the drying step.

As a result, since the surface of the light emitting layer is rough, the contact area between the light emitting layer and a layer staked thereon is increased. Therefore, as described above, it is possible to accomplish enhancement of reliability, brightness, and light emission efficiency of the obtained organic EL element.

In the method of manufacturing an organic EL device, it is preferable that a hole injecting/transporting layer serving as the functional layer is formed by performing the coating step and the drying step. As a result, since the surface of the hole injecting/transporting layer is rough, the contact area between the hole injecting/transporting layer and a layer stacked thereon is increased. Therefore, as described above, it is possible to accomplish enhancement of reliability, brightness, and light emission efficiency of the obtained organic EL element.

### BRIEF DESCRIPTION OF THE DRAWINGS

FIG. 1 is a side cross-sectional view illustrating an important part of an organic EL device according to the present invention;

FIG. 2 is a process diagram illustrating a method of manufacturing the organic EL device;

FIG. 3 is a diagram illustrating a process subsequent to FIG. 2;

FIG. 4 is a diagram illustrating a process subsequent to FIG. 3; and

FIG. 5 is a diagram illustrating a process subsequent to FIG. 4.

### DETAILED DESCRIPTION OF EMBODIMENTS

Hereinafter, the present invention will be described in detail.

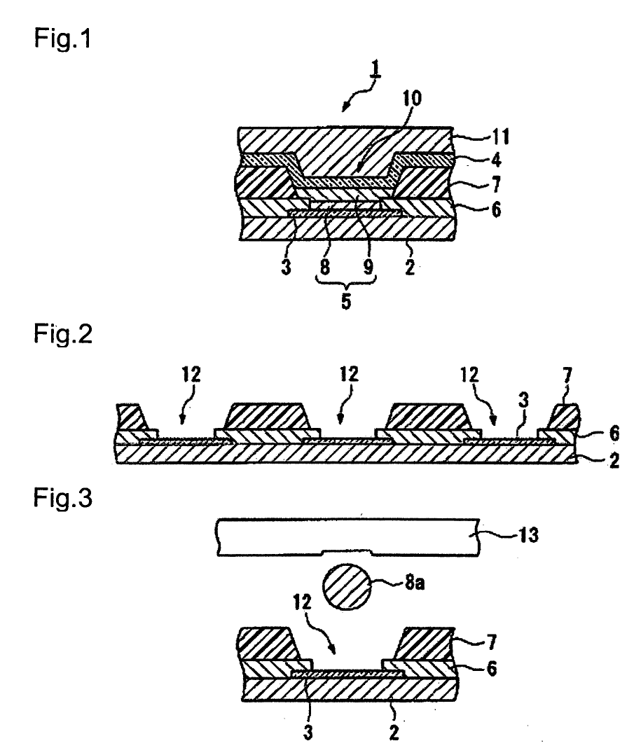

FIG. 1 is a side cross-sectional view illustrating an important part of an embodiment of an organic EL device having an organic EL element according to the present invention. In FIG. 1, reference numeral 1 denotes an organic EL device and reference numeral 10 denotes an organic EL element. The organic EL device 1 is an organic EL device of a so-called bottom emission type in which a transparent electrode (pixel electrode) 3 serving as a positive electrode and a cathode 4 are provided on a substrate 2, a functional layer 5 is provided between the transparent electrode 3 and the cathode 4, and light emitted from the functional layer 5 is irradiated from the substrate 2. Here, the transparent electrode 3, the cathode 4, and the functional layer 5 provided therebetween constitute the organic EL element 10.

The substrate 2 is constructed by forming driving elements (not shown) including TFT elements or various wires on a transparent substrate (not shown) such as a glass substrate, and the transparent electrode 3 is formed on the driving elements or various wires with an insulating film or a planarization film therebetween.

The transparent electrode 3 is patterned and formed in each single dot area to be formed on the substrate 2 and is connected to the driving elements including the TFT elements or various wires. In the present embodiment, the transparent electrode is made of indium tin oxide (ITO).

Here, in the present embodiment, the transparent electrode 3 made of ITO is formed to have some degree of surface roughness. Specifically, an arithmetic-mean surface roughness Ra (ITO) (hereinafter, referred to as Ra) of the transparent electrode 3 preferably has a range satisfying the following expression:
0.5 nm≦Ra(ITO)≦thickness of a layer on the transparent electrode 3

In the present embodiment, the layer on the transparent electrode 3 is a hole injecting/transporting layer 8 as described later.

In the present embodiment, it is more preferable that Ra (ITO) has a range satisfying the following expression:
0.5 nm≦Ra(ITO)≦5 nm

The transparent electrode 3 is formed to have such Ra for the purpose of giving a proper degree of surface roughness to the surface of the functional layer (the hole injecting/transporting layer 8) stacked on the transparent electrode. In this way, it is easy in manufacture and preferable that the surface of the transparent electrode 3 serving as a base is roughened.

When Ra of the surface of the transparent electrode 3 is less than 0.5 nm, the effect of giving a proper degree of surface roughness to the surface of the functional layer cannot be sufficiently obtained.

When Ra is more than 5 nm, the film-forming ability of the layer to be formed on the transparent electrode 3 is deteriorated and thus it is not preferable. Specifically, when the layer is formed on the transparent electrode using an inkjet method (a liquid droplet ejecting method) as described later, wettability is poor due to the large surface roughness, for example, even if the surface is processed using oxygen plasma. Therefore, it is difficult to uniformly form the layer.

When Ra of the surface of the transparent electrode 3 is greater than the thickness of the layer (hole injecting/transporting layer 8) on the transparent electrode 3, thinned portions are generated in the layer stacked on the transparent electrode, or the transparent electrode 3 and the cathode 4 can be easily short-circuited. As a result, the leakage of the formed element can be easily increased.

The hole injecting/transporting layer 8 has a thickness of 50 to 60 nm, and it is thus preferable in the present embodiment that Ra (ITO) of the surface of the transparent electrode 3 is less than or equal to the thickness of the hole injecting/transporting layer 8, that is, 50 to 60 nm.

As shown in FIG. 1, the functional layer 5 including the hole injecting/transporting layer 8 and the light emitting layer 9 is stacked on the transparent electrode 3.

The hole injecting/transporting layer 8 is formed to have a surface roughness large enough in the present invention. Specifically, it is preferable that Ra (HIT) of the surface of the hole injecting/transporting layer 8 has a range satisfying the following expression. Here, Ra (HIT) of the surface of the hole injecting/transporting layer 8 mentioned herein means Ra in a state where the layer has been stacked on the transparent electrode 3.
1 nm≦Ra(HIT)≦thickness of the light emitting layer 9

It is more preferable that Ra (HIT) has a range satisfying the following expression.
1 nm≦Ra(HIT)≦2 nm

The hole injecting/transporting layer 8 is formed to have such a surface roughness for the purpose of increasing the contact area in the interface with the light emitting layer 9 stacked thereon.

That is, when the surface roughness is less than 1 nm, the contact area with the light emitting layer 9 cannot be sufficiently increased and the carrier injection efficiency between the light emitting layer 9 and the hole injecting/transporting layer is decreased, so that it is not preferable.

When Ra is greater than 2 nm, the adhesiveness to the light emitting layer 9 is rather decreased, and reliability of the formed element is decreased, so that it is not preferable.

When the surface roughness is greater than the thickness of the light emitting layer 9, thinned portions can be easily generated in the light emitting layer, or the hole injecting/transporting layer 8 and the cathode 4 can be easily short-circuited. As a result, the leak current of the formed element can be easily increased, so that it is not preferable.

The light emitting layer 9 has a thickness of 80 nm, and it is preferable in the present embodiment that Ra (HIT) of the surface of the hole injecting/transporting layer 8 is equal to or less than the thickness of the light emitting layer 9, that is, equal to or less than 80 nm.

As a base material for the light emitting layer 9, well-known luminescent materials capable of emitting fluorescence or phosphorescence are used. Specifically, in the present embodiment, luminescent materials of which emission wavelength bands correspond to three primary colors of light, respectively, are used to perform full color display. That is, one pixel is composed of three light emitting layers (dots) of a light emitting layer of which the emission wavelength band corresponds to red, a light emitting layer of which the emission wavelength band corresponds to green, and a light emitting layer of which the emission wavelength band corresponds to blue, and the organic EL device 1 can carry out full color display as a whole by emission of light from the light emitting layers with gray scales.

Specifically, polymer materials such as polyparaphenylene vinylene materials, polyfluorene materials, etc. are suitably used as the base material for the light emitting layer 9.

The polymer materials may be doped with tetraphenyl butadiene dye, perylene dye, coumarin dye, rubrene dye, Nile red, etc., or may be doped with triphenylamine materials, hydrazine materials, and stilbene materials as a hole transporting material, or may be doped with oxadiazole materials, triazole materials, etc. as an electron transporting material.

The light emitting layer 9 is formed to have a surface roughness large enough in the present invention. Specifically, it is preferable that Ra (EL) of the surface of the light emitting layer 9 has a range satisfying the following expression. Here, Ra (EL) of the surface of the light emitting layer 9 mentioned herein means Ra in a state where the light emitting layer has been stacked on the hole injecting/transporting layer 8.
0.3 nm≦Ra(EL)≦thickness of the cathode 4

It is more preferable that Ra (EL) has a range satisfying the following expression.
0.3 nm≦Ra(EL)≦2 nm

The light emitting layer 9 is formed to have such a surface roughness for the purpose of increasing the contact area in the interface with the cathode 4 stacked thereon.

That is, when Ra is less than 0.3 nm, the contact area with the light emitting layer 9 cannot be sufficiently increased and the carrier injection efficiency between the cathode 4 and the light emitting layer is decreased, so that it is not preferable. When Ra (EL) of the surface of the light emitting layer 9 has a roughness greater than an atomic radius of metal atoms used in the cathode 4, it is possible to more efficiently inject many electrons into the light emitting layer 9, so that it is preferable. Specifically, as described later, when the cathode 4 is composed of an electron injecting layer and a cathode layer, by allowing Ra (EL) of the surface of the light emitting layer 9 to have a roughness greater than an atomic radius of metal atoms used in the electron injecting layer, it is possible to more efficiently inject many electrons into the light emitting layer 9, so that it is preferable.

If the surface roughness is greater than the thickness of the cathode 4, portions to which metal is not attached are partially generated in the surface of the light emitting layer 9 when a metal cathode is formed on the light emitting layer 9 using a deposition method and specifically when the electron injecting layer is formed with a thickness in the order of nanometers.

If the surface roughness is greater than 2 nm, portions which are singularly thin are generated, or portions in which the electron injecting layer is not formed are partially generated when a thin electron injecting layer is formed with a thickness in the order of nanometers. As a result, it is not possible to efficiently perform the injection of electrons.

The cathode 4 is formed to cover all the pixel area, and is formed, for example, by sequentially stacking a Ca layer and an Al layer in the order from the light emitting layer 9 side. However, in the dot area performing the emission of blue color, an electron injecting layer (not shown) made of, for example, LiF is provided on the light emitting layer 9, and a stacked film including the electron injecting layer and the cathode layer composed of the Ca layer and the Al layer may be used as the cathode 4.

A sealing layer 11 is formed on the cahtode 4. The sealing layer 11 has a well-known structure including a protective layer, an adhesive layer, and a sealing substrate.

In order to manufacture an organic EL device 1 having the above-mentioned structure, first, the substrate 2 is obtained by forming TFT elements or various wires on a transparent substrate and forming an interlayer insulating film or a planarization film, similarly to conventional cases.

Next, an ITO film is formed on the substrate 2 using, for example, a sputtering method. Specifically, a target for forming a transparent conductive film, that is, a target made of indium oxide (In₂O₃) containing tin oxide (SnO₂) with a concentration of 10 percent by weight, and the substrate 2 are placed into a bell jar (film forming chamber) of a radio sputtering apparatus, and they are opposed to each other. Subsequently, carrier gas such as argon gas containing oxygen gas at a volume ratio of 0.2 to 2.0% is introduced into the bell jar, thereby making the argon gas pressure in the bell jar be a predetermined gas pressure. In this state, by applying predetermined radio power between the substrate 2 and the targets and depositing atomic particles on the substrate 2, the ITO film as a transparent conductive film is formed. Thereafter, by patterning the ITO film, the transparent electrode 3 is formed. The transparent electrode 3 obtained in this way has the surface roughness Ra (ITO) described above.

Subsequently, an inorganic bank 6 made of SiO₂ is formed on the substrate 2 to surround the transparent electrode 3 and an organic bank 7 made of resin is formed on the inorganic bank 6. As a result, as shown in FIG. 2, a concave portion 12 is formed on the transparent electrode 3. An example of the material used for the organic bank 7 may include polyimide, acryl resin, etc. Materials obtained by previously introducing fluorine element into the materials may be used.

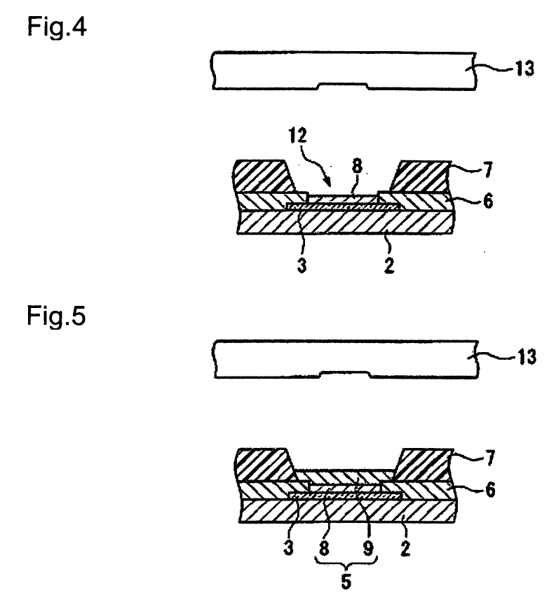

Next, the wettability of the substrate 2 is controlled by performing the substrate 2 having the concave portion 12 surrounded with the inorganic bank 6 and the organic bank 7 continuously with oxygen plasma and CF₄ plasma. Subsequently, the hole injecting/transporting layer 8 is formed in the concave portion 12 using an inkjet method (liquid droplet ejecting method). That is, as shown in FIG. 3, by performing a coating step of selectively ejecting (applying) a base material 8a for the hole injecting/transporting layer 8 into the concave portion 12 from a liquid droplet ejecting head (inkjet head) 13 using the inkjet method (liquid droplet ejecting method) and then performing a drying step of drying the base material 8a using a vacuum dry method, the hole injecting/transporting layer 8 is formed on the transparent electrode 3, as shown in FIG. 4.

Here, as the base material 8a for the hole injecting/transporting layer 8, a material obtained by dissolving a dispersion solution of 3,4-polyethylene dioxythiophene/polystyrenesulfonic acid (PEDOT/PSS) (made by H.C. Stark Co.: BaytronP (product name)) in a mixture solvent of isopropyl alcohol, N-methylpyrrolidone, and 1,3-dimethyl-imidazolidinone as polar solvent is used. In the component ratios of the base material 8a, the dispersion solution of 3,4-polyethylene dioxythiophene/polystyrenesulfonic acid (PEDOT/PSS) is 11.08%, polystyrenesulfonic acid is 1.44%, isopropyl alcohol is 10%, N-methylpyrrolidone is 27.48%, and 1,3-dimethyl-imidazolidinone is 50%.

The vacuum dry method is used in the drying step of drying the base material 8a. The vacuum dry method is a method of rapidly drying the substrate 2 coated with the base material 8a in a vacuum chamber, where the drying step can be performed at a normal temperature (room temperature) without heating the substrate. That is, the solvent is removed to form a film by setting the substrate 2 into the vacuum chamber, once decompressing the vacuum chamber to 1 Torr from atmospheric pressure, and finally making the degree of vacuum equal to or less than 10⁻⁵ Torr. The time period for decompression from atmospheric pressure to 1 Torr preferably ranges 3 to 5 minutes. When the time period for decompression from atmospheric pressure to 1 Torr is less than 3 minutes, bumps of the coated base material 8a can be easily generated, thereby increasing the possibility of generation of defects. When the time period is greater than 5 minutes, Ra of the surface of the hole injecting/transporting layer 8 to be formed is decreased, so that a suitable degree of surface roughness is not obtained. At this time, the decompression of the vacuum chamber may be carried out at an almost constant rate by adjusting the exhaust rate of the vacuum chamber. As a result, the reproducibility of Ra of the surface of the hole injecting/transporting layer 8 to be formed can be further enhanced. At the time of decompression, the substrate temperature may be kept constant. As a result, it is possible to suppress generation of bumps of the coated base material 8a at the time of decompression or to further enhance the reproducibility of Ra of the surface of the hole injecting/transporting layer 8 to be formed.

The time period until the degree of vacuum is made to be equal to or less than 10−⁵ Torr after the decompression to 1 Torr is properly set in advance through experiments. Thereafter, by performing a baking step at 200° C. in the atmosphere for 10 minutes, the hole injecting/transporting layer 8 is formed.

When the hole injecting/transporting layer 8 is formed using the vacuum dry method, the base material is dried at a normal temperature for a short time during the drying step, so that the surface thereof becomes a properly roughened surface, that is, a rough surface and has the above-mentioned range of Ra (HIT). Such Ra (HIT) can be more easily obtained because the transparent electrode 3 as a base has the above-mentioned roughness.

The hole injecting/transporting layer 8 may be formed by coating the base material 8a on the transparent electrode 3 using a spin coating method and then performing the baking step at 200° C. in the atmosphere for 10 minutes. However, in this case, Ra (HIT) is relatively small. A dry method requiring a long time period such as a natural dry method is not preferable, because Ra (HIT) is greater than 2 nm. A dry method of performing the drying step for a short time by applying high energy such as radiation from a lamp is not also preferable, because Ra (HIT) is less than 1 nm to the contrary.

Next, as shown in FIG. 5, the light emitting layer 9 is formed on the hole injecting/transporting layer 8 in the concave portion 12. The liquid droplet ejecting method (the inkjet method) is suitably used to form the light emitting layer 9. That is, at the time of formation of the light emitting layer 9, it is necessary to separately form the light emitting layer for red, the light emitting layer for green, and the light emitting layer for blue. The respective light emitting layers 9 can be easily formed only by distributing the base materials for the respective light emitting layers at desired positions using the liquid droplet ejecting method. In addition, at the time of formation of the light emitting layer 9, it is preferable that a solvent not re-dissolving the hole injecting/transporting layer 8 is used as the solvent for dissolving the base materials for the light emitting layers, in that the hole injecting/transporting layer 8 can be kept in a good condition.

Here, as the base material for the light emitting layer 9, a composition in which an organic luminescent material composed of the polyfluorene material is dissolved in cyclo hexylbenzene by 0.8 percent by weight is used.

The vacuum dry method is used in the drying step of drying the composition (base material) similarly to the case of the hole injecting/transporting layer 8. That is, also in the drying step, the light emitting layer 9 is formed by setting the substrate 2, on which the composition (base material) is coated, into the vacuum chamber, once decompressing the vacuum chamber to 1 Torr for 3 to 5 minutes, and then finally making the degree of vacuum equal to or less than 10−⁵ Torr. The time period for making the degree of vacuum equal to or less than 10−⁵ Torr after decompression to 1 Torr is properly set in advance through experiments, similarly to the case of the hole injecting/transporting layer 8.

In forming the light emitting layer 9, the light emitting layer 9 is obtained by performing an annealing step at 130° C. in an atmosphere of nitrogen for 30 to 60 minutes after the vacuum drying step.

When the light emitting layer 9 is formed using the vacuum dry method, the base material is dried at the normal temperature for a short time without heating, so that the surface thereof becomes a properly roughened surface, that is, a rough surface, and has the above-mentioned range of Ra (EL). Such Ra (EL) can be more easily obtained because the hole injecting/transporting layer 8 as a base has the above-mentioned roughness.

Next, the cathode 4 having a stacked structure of Ca/Al is formed by forming a Ca (calcium) layer with a thickness of, for example, 20 nm to cover the light emitting layer 9a and the organic bank 7 and forming an Al (aluminum) layer thereon, using a deposition method similarly to the conventional case.

Although not described in detail herein, the electron injecting layer may be formed by selectively depositing LiF on the light emitting layer 9 for blue using a mask, and the cathode 4 may be allowed to include the electron injecting layer.

Thereafter, by forming a protective layer and an adhesive layer on the cathode 4 and bonding a sealing substrate thereto, the organic EL device 1 shown in FIG. 1 is obtained.

In the organic EL device 1 (organic EL element 10) obtained in this way, since the hole injecting layer 8 and the light emitting layer 9 have a predetermined range of surface roughness, respectively, in the interface between the hole injecting layer 8 and the light emitting layer 9 and the interface between the light emitting layer 9 and the cathode 4, the contact areas between the respective functional layers (hole injecting layer 8 and light emitting layer 9) and a layer stacked thereon are increased, thereby enhancing the adhesiveness therebetween. As a result, it is possible to accomplish the extension of lifetime and it is also possible to accomplish increase in efficiency and brightness due to improvement of the injection efficiency of carriers.

According to the method of manufacturing the organic EL device 1 (organic EL element 10), since the hole injecting layer 8 and the light emitting layer 9 are made to have a roughened surface by applying the base materials for the hole injecting layer 8 and the light emitting layer 9 using the liquid droplet ejecting method (inkjet method), respectively, and then drying the base materials using the vacuum dry method, the organic EL device 1 (organic EL element 10) obtained as described above can have enhanced reliability and quality.

Although it has been described in the aforementioned embodiment that the present invention is applied to the organic EL device of a bottom emission type, the present invention is not limited to the embodiment, but the present invention may be applied to an organic EL device of a so-called top emission type in which the light is radiated from the opposite direction from the substrate.

The organic EL device (organic EL element) according to the present invention can be suitably used as a display unit of various electronic apparatus such as a portable information processing apparatus of a word processor, a PC, etc., a mobile phone, a wristwatch type electronic apparatus, and the like. As a result, it is possible to embody an electronic apparatus having high reliability.

### EXPERIMENTAL EXAMPLE

The organic EL element 10 (organic EL device 1) was manufactured on the basis of the manufacturing method of the above-mentioned embodiment as follows.

First, as an embodiment sample of the present invention, an hole injecting/transporting layer 8 was formed on a transparent electrode 3 having Ra (ITO) of 0.6 nm by performing a coating step using a liquid droplet ejecting method (inkjet method), a drying step using a vacuum dry method, and a baking step. Then, a cross-sectional profile of the obtained hole injecting/transporting layer 8 was inspected with a stylus-type thickness tester. As a result, the cross-sectional profile was approximately flat. In addition, Ra (HIT) of a predetermined area was measured into 1.3 nm, using a scanning atomic force microscope (AFM).

For the purpose of comparison, a hole injecting/transporting layer 8 was formed by applying a base material for the hole injecting/transporting layer 8 using the liquid droplet ejecting method (inkjet method) and then drying the base material using a heating method (Comparative sample 1). A hole injecting/transporting layer 8 was formed by applying the base material using the liquid droplet ejecting method (inkjet method) and then drying the base material using a natural dry method (Comparative sample 2). As a result of inspection of cross-sectional profiles of the respective hole injecting/transporting layers 8 formed in the aforementioned way, Comparative sample 1 had a concave profile and Comparative sample 2 had an approximately flat profile. Ra (HIT) of Comparative sample 1 was 0.8 nm and Ra (HIT) of Comparative sample 2 was 4.0 nm.

Here, as a result of inspection of adhesiveness of the respective hole injecting/transporting layers 8 to the base (transparent electrode 3) through a peeling test using an adhesive tape, it was confirmed that the peeling is not generated and the adhesiveness is excellent.

Next, the respective light emitting layers 9 were formed on the embodiment sample and Comparative samples 1 and 2 by performing the coating step using the liquid droplet ejecting method (inkjet method) and the drying step using the vacuum dry method. As a result of inspection of the cross-sectional profile of the light emitting layer 9 according to the embodiment sample, the cross-sectional profile had an approximately flat shape and the surface roughness Ra (EL) was 0.8 nm.

In Comparative sample 1, when the light emitting layer 9 was formed using the same method, the light emitting layer had a concave cross-sectional profile and a uniform thickness in a pixel was not obtained. Consequently, uniform emission of light was not obtained from the manufactured element. In Comparative sample 2, when the light emitting layer was formed using the same method, the light emitting layer having an approximately flat profile was obtained. However, as a result of inspection of the adhesiveness to the hole injecting layer through the peeling test using the adhesive tape, the peeling was generated in the whole surface and it was thus confirmed that sufficient adhesiveness is not obtained.

Independently of the samples, for the purpose of comparison, a light emitting layer 9 was formed on the aforementioned samples in which the hole injecting/transporting layer 8 had been formed, by coating the base material for the light emitting layer 9 using a spin coating method (Comparative sample 3). In addition, a light emitting layer 9 was formed by applying the base material using the liquid droplet ejecting method (inkjet method) and then drying the base material using the natural dry method (Comparative sample 4). As a result of inspection of the cross-sectional profiles of the respective light emitting layer 9 formed as described above, Comparative sample 3 and Comparative sample 4 had an approximately flat profile. However, Ra (EL) of Comparative sample 3 was 0.2 nm and Ra (EL) of Comparative sample 4 was 3.0 nm.

A cathode was formed on the respective light emitting layers 9 formed as described above, and then adhesiveness of the cathode to the light emitting layer was inspected through a peeling test using an adhesive tape. As a result, it was confirmed that the peeling is not generated in the embodiment sample and the adhesiveness is thus excellent. On the other hand, it was confirmed that the peeling of the entire surfaces of the light emitting layers 9 was generated in Comparative samples 3 and 4 and thus the adhesiveness was not sufficient.

The element lifetimes of the embodiment sample and Comparative samples 1 to 4 were measured. The element lifetime was defined as a time period until the brightness is decreased to half under driving with static current when initial brightness is set to 3000 Cd/m².

As a result of measurement of the element lifetime of the respective samples, assumed that the element lifetime of the embodiment sample is 1, the element lifetime of Comparative sample 1 was 0.6, the element lifetime of Comparative sample 2 was 0.5, the element lifetime of Comparative sample 3 was 0.7, and the element lifetime of Comparative sample 4 was 0.4. Accordingly, it could be seen that the embodiment sample according to the present invention has the longest element lifetime.

1. A method of manufacturing an organic EL device having a functional layer including at least a light emitting layer between a pair of electrodes,
wherein at least one layer of the functional layer is formed by performing a coating step of applying a base material for the functional layer by using a liquid droplet ejecting method and a drying step of drying the base material applied in the coating step by using a vacuum dry method.

2. The method of manufacturing an organic EL device according to claim 1,
wherein the light emitting layer is formed by performing the coating step and the drying step.

3. The method of manufacturing an organic EL device according to claim 1,
wherein a hole injecting/transporting layer serving as the functional layer is formed by performing the coating step and the drying step.

4. The method of manufacturing an organic EL device according to claim 1,
wherein the drying step of at least one layer of the functional layer is carried out by adjusting an exhaust rate such that a time period for decompression from atmospheric pressure to 1 Torr is set to a predetermined value.

5. The method of manufacturing an organic EL device according to claim 4,
wherein the time period for decompression from atmospheric pressure to 1 Torr ranges 3 to 5 minutes.

6. The method of manufacturing an organic EL device according to claim 4,
wherein the decompression from atmospheric pressure to 1 Torr is carried out at a constant rate.

7. The method of manufacturing an organic EL device according to claim 1,
wherein a substrate temperature is kept constant at the time of the decompression from atmospheric pressure.

8. The method of manufacturing an organic EL device according to claim 2,
wherein an arithmetic-mean surface roughness of the surface of the light emitting layer has a range of 0.3 nm≦Ra≦2 nm.

9. The method of manufacturing an organic EL device according to claim 3,
wherein an arithmetic-mean surface roughness of the surface of the hole injecting/transporting layer has a range of 1 nm≦Ra≦2 nm.
